(19) United States
(12) Patent Application Publication
(10) Pub. No.: US 2023/0191402 A1
(43) Pub. Date: Jun. 22, 2023

(54) MICROFLUIDIC DEVICE AND LIQUID CONTROL SYSTEM THEREFOR

(71) Applicant: National University of Singapore, Singapore (SG)

(72) Inventors: Haitao Zhao, Singapore (SG); Yan Zhang, Singapore (SG); Huilin Shao, Singapore (SG)

(21) Appl. No.: 17/925,533

(22) PCT Filed: May 18, 2021
(86) PCT No.: PCT/SG2021/050270

§ 371 Date: Nov. 15, 2022

(30) Foreign Application Priority Data
May 18, 2020 (SG) 10202004595V

(51) Int. Cl. B01L 3/00; B33Y 10/00; B33Y 50/02

(52) U.S. Cl. CPC B01L 3/502715; B33Y 10/00; B01L 3/502738; B33Y 50/02; B01L 2400/0487; B01L 2300/0861; B01L 2300/049; B01L 2300/14

(57) ABSTRACT

The present invention relates to a microfluidic device (100) for mixing liquids, wherein the microfluidic device (100) comprises a plurality of device inlets (110), each device inlet (110) for receiving a liquid; a chamber assembly (120) comprising a set of chamber inlets (122) in fluid communication with the device inlets (110); a mixing chamber (124) for receiving the liquids through the chamber inlets (122); and a plurality of chamber outlets (126) for communicating the liquids away from the mixing chamber (124); and a set of device outlets (130) in fluid communication with the chamber outlets (126), wherein the chamber outlets (126) are spaced around the mixing chamber (124) such that the mixing chamber (124) facilitates uniform mixing of the liquids communicating from the chamber inlets (122) to the chamber outlets (126). The invention also relates to a method of additive manufacturing a product comprising the microfluidic device as well as a liquid control system for controlling liquids in a microfluidic device.

### CROSS REFERENCE TO RELATED APPLICATION(S)

The present disclosure claims the benefit of Singapore Patent Application No. 10202004595V filed on 18 May 2020, which is incorporated in its entirety by reference herein.

### TECHNICAL FIELD

The present disclosure generally relates to a microfluidic device and a liquid control system for the microfluidic device. More particularly, the present disclosure describes various embodiments of a microfluidic device for mixing liquids, as well as a liquid control system for controlling liquids in a microfluidic device.

### BACKGROUND

Microfluidic devices have been used in various applications including medical diagnostics and biological/chemical assays. Controllable and quick mixing of liquids is important for microfluidic devices that are used for assays which would involve many liquid reagents and samples. However, liquid flows in miniaturized channels of these microfluidic devices are highly laminar and not turbulent. Consequently, traditional turbulent mixing between liquids cannot occur and the liquids would not be uniformly mixed. For microfluidic devices used in assays, this non-uniform mixing would likely compromise the assay results.

Therefore, in order to address or alleviate at least one of the aforementioned problems and/or disadvantages, there is a need to provide an improved microfluidic device for mixing liquids.

### SUMMARY

According to a first aspect of the present disclosure, there is a microfluidic device for mixing liquids. The microfluidic device comprises:
a plurality of device inlets, each device inlet for receiving a liquid;
a chamber assembly comprising:
   a set of chamber inlets in fluid communication with the device inlets;
   a mixing chamber for receiving the liquids through the chamber inlets; and
   a plurality of chamber outlets for communicating the liquids away from the mixing chamber; and
a set of device outlets in fluid communication with the chamber outlets,
wherein the chamber outlets are spaced around the mixing chamber such that the mixing chamber facilitates uniform mixing of the liquids communicating from the chamber inlets to the chamber outlets.

According to a second aspect of the present disclosure, there is a liquid control system for controlling liquids in a microfluidic device. The liquid control system comprises:
a pneumatic device for pumping a gas;
a device connector for connecting to the microfluidic device, the device connector comprising a plurality of inlet connectors, each inlet connector for fluidically connecting to a respective device inlet of the microfluidic device;
a valve assembly comprising a plurality of valves for fluidically connecting between the pneumatic device and device connector, each valve fluidically communicable with a respective inlet connector to control communication of the gas from the pneumatic device through the respective valve to the respective inlet connector; and
a valve controller configured to independently control operation of each valve to, for each valve, controllably communicate the gas through the respective valve and respective inlet connector to the respective device inlet,
wherein controlled communication of the gas to each device inlet thereby controls communication of a liquid in the respective device inlet.

A microfluidic device for mixing liquids and a liquid control system for controlling liquids in a microfluidic device according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIGS. 1 and 2 are illustrations of a microfluidic device for mixing liquids, according to embodiments of the present disclosure.

FIG. 3 is an illustration of a chamber assembly of the microfluidic device, according to embodiments of the present disclosure.

FIG. 4 is an illustration of a mixing chamber of the chamber assembly, according to embodiments of the present disclosure.

FIG. 5 is an illustration of a retention valve of the microfluidic device, according to embodiments of the present disclosure.

FIG. 6 is an illustration of a debubbling assembly of the microfluidic device according to embodiments of the present disclosure.

FIGS. 7 and 8 are illustrations of a liquid control system for controlling liquids in the microfluidic device, according to embodiments of the present disclosure.

FIG. 9 is an illustration of a process of controlling the liquids, according to embodiments of the present disclosure.

### DETAILED DESCRIPTION

For purposes of brevity and clarity, descriptions of embodiments of the present disclosure are directed to a microfluidic device for mixing liquids and a liquid control system for controlling liquids in a microfluidic device, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “a” and “an” are defined as one or more than one. The use of “/” in a figure or associated text is understood to mean “and/or” unless otherwise indicated. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range. The terms “first”, “second”, etc. are used merely as labels or identifiers and are not intended to impose numerical requirements on their associated terms.

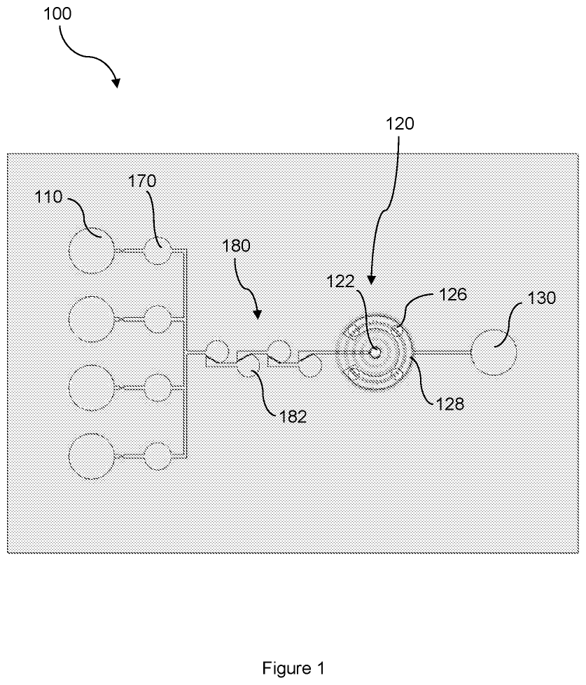

In representative or exemplary embodiments of the present disclosure, there is a microfluidic device 100 for mixing liquids, as shown in FIG. 1. Notably, the microfluidic device 100 operates based on the behaviour of liquids at the microscale level. The liquids may be reagents and samples that react together upon mixing for assaying. For example, a known reagent may mix with a biological sample (e.g. urine or blood) to assay and test for certain compounds in the sample.

The microfluidic device 100 includes a plurality of device inlets 110 for receiving the liquids. More specifically, each device inlet 110 is arranged for receiving a liquid. For example, a first device inlet 110 is for receiving a first liquid and a second device inlet 110 is for receiving a second liquid, wherein the first and second liquids are subsequently mixed in the microfluidic device 100. In one embodiment as shown in FIG. 1, the microfluidic device 100 has four device inlets 110 for receiving up to four liquids, each device inlet 110 for receiving a respective one of the four liquids.

The microfluidic device 100 further includes a chamber assembly 120. The chamber assembly 120 includes a set of one or more chamber inlets 122 in fluid communication with the device inlets 110. The chamber assembly 120 further includes a mixing chamber 124 for receiving the liquids through the chamber inlets 122. The chamber assembly 120 further includes a plurality of chamber outlets 126 for communicating the liquids away from the mixing chamber 124. The microfluidic device 100 further includes a set of one or more device outlets 130 in fluid communication with the chamber outlets 126. The liquids thus communicate away from the mixing chamber 124 via the chamber outlets 126 and exit the microfluidic device 100 via the device outlets 130. The chamber assembly 120 may include a guiding channel 128 for guiding the liquids from the chamber outlets 126 to the device outlets 130.

When the microfluidic device 100 is in use, the liquids are received by the device inlets 110 and communicate from the device inlets 110 to the chamber inlets 122. The liquids then communicate from the chamber inlets 122 to the mixing chamber 124 where they mix together. The mixed liquids then communicate away from the mixing chamber 124 via the chamber outlets 126. Further, the chamber outlets 126 are spaced around the mixing chamber 124 such that the mixing chamber 124 facilitates uniform mixing of the liquids communicating from the chamber inlets 122 to the chamber outlets 126.

The liquids flow across the mixing chamber 124 from the chamber inlets 122 towards the chamber outlets 126 in multiple directions which suppresses non-uniform mixing of the liquids. This improves the homogeneity of the mixed liquids and enables better results to be obtained from measurements on the mixed liquids. For example, liquid reagents and samples that are homogeneously mixed can increase reaction efficiency and robustness, allowing measurements, such as assays, to be performed repeatedly on different sets of reagents and samples. The microfluidic device 100 may include a measurement element for measuring the mixed liquids in the mixing chamber 124. For example, the measurement element may be disposed in the mixing chamber 124 and may include a sensing element for sensing a reaction of the mixed liquids in the mixing chamber 124. Having the measurement element in the mixing chamber 124 can streamline the measurement and assaying process.

In some embodiments, the chamber inlets 122, mixing chamber 124, and chamber outlets 126 are arranged on the same plane or layer. In some embodiments, the chamber inlets 122, mixing chamber 124, and chamber outlets 126 are arranged on separate planes or layers. For example as shown in FIG. 2, the chamber assembly 120 includes a first layer 140, a second layer 150, and a third layer 160, wherein the second layer 150 interposes the first layer 140 and third layer 160. The first layer 140 includes the chamber inlets 122 and chamber outlets 126. The second layer 150 includes vias 152 respectively connecting each chamber inlet 122 and chamber outlet 126 to the mixing chamber 124. The third layer 160 includes the mixing chamber 124 and optionally the measurement or sensing element. The microfluidic device 100 may include a cover layer 165 overlaying the first layer 140.

By arranging the mixing chamber 124 in the separate third layer 160, the mixing chamber 124 can be made larger relative to the overall size of the microfluidic device 100, as compared to the mixing chamber 124 being on the same layer as the chamber inlets 122 and chamber outlets 126. A larger mixing chamber 124 can increase the volume of mixed liquids and improve mixing efficiency and uniformity. The larger mixing chamber 124 can also accommodate a wider range of measurement or sensing elements of varying dimensions and for different detection methodologies.

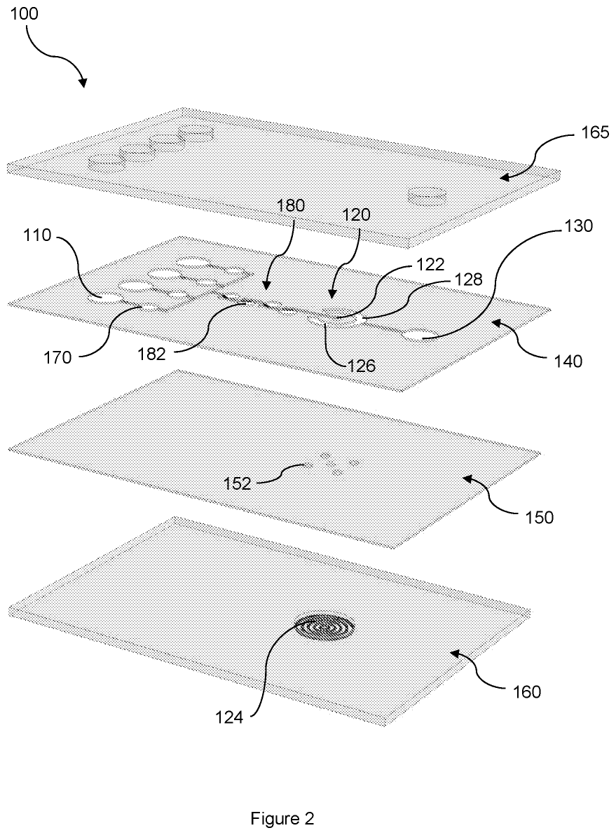

With reference to FIG. 3, the chamber inlets 122 may include a first chamber inlet 122. The chamber outlets 126 may be equidistantly spaced from the first chamber inlet 122 and equidistantly spaced from each other. The chamber outlets 126 may be spaced around a periphery of the mixing chamber 124. The first chamber inlet 122 may be positioned to direct the liquids into a centre area of the mixing chamber 124. This arrangement of the first chamber inlet 122 and chamber outlets 126 enables the liquids to flow into the mixing chamber 124 at its centre area, spread out to its periphery, and then exit the mixing chamber 124 via the chamber outlets 126 at the periphery. The liquids thus flow radially from the centre area of the mixing chamber 124 and exit via respective pathways through the peripheral chamber outlets 126, improving the mixing efficiency and homogeneity of the mixed liquids.

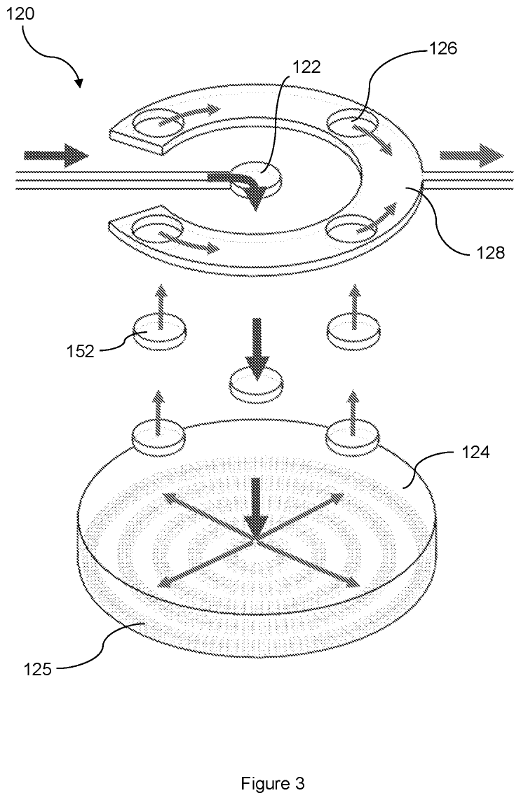

In some embodiments with reference to FIG. 4, the mixing chamber 124 includes an array of guiding elements 125 for regulating communication of the liquids from the first chamber inlet 122 to the chamber outlets 126. The guiding elements 125 may be formed on the top surface and/or bottom surface of the mixing chamber 124. The guiding elements 125 may be in the form of micropillars protruding from the surface of the mixing chamber 124. Alternatively, the guiding elements 125 may be in the form of microwells recessed into the surface of the mixing chamber 124. The micropillars/microwells can be formed by various processes such as laser engraving. Alternatively, the micropillars/microwells are integrally formed with the microfluidic device 100 by additive manufacturing.

As shown in FIG. 4, the guiding elements 125 may be concentrically arranged such that the liquids are communicated radially from the first chamber inlet 122 to the chamber outlets 126. More specifically, there is a plurality of concentric ring layers 127 arranged with respect to the first chamber inlet 122 at the centre. Each ring layer 127 has a plurality of guiding elements 125 spaced apart from each other so that liquids can flow through the gaps between the guiding elements 125. The guiding elements 125 are arranged closer to each other in the circumferential direction (within the same ring layer 127) than in the radial direction (across different ring layers 127).

When the liquid flows into the mixing chamber 124 via the first chamber inlet 122, the mixing chamber 124 will be filled radially due to the arrangement of the concentric ring layers 127. Specifically, when a part of the liquid front reaches a ring layer 124, the liquid experiences resistive capillary forces from the guiding elements 125. The guiding elements 125 resists the liquid flow and guides the liquid to move through the gaps between the guiding elements 125 towards the remaining unfilled regions where there is less resistance. When the entire ring layer 127 is filled, the liquid front will move ahead and fill the space defined by the next ring layer 127. The guiding elements 125 thus help to spread the liquid front radially from the first chamber inlet 122 at the centre to the chamber outlets 126 at the periphery. By regulating the spread of the liquid front, the mixing chamber 124 can be filled before the liquid front reaches the chamber outlets 126. This mitigates the risk of bubble trapping or retention and blockage at the periphery, consequently improving uniform mixing of the liquids and achieving more reliable measurement results, especially if the mixing chamber 124 is large.

In some embodiments as shown in FIGS. 2 and 3, the second layer 150 is disposed below the first layer 140, and the third layer 160 is disposed below the second layer 150. It will be appreciated that in some other embodiments, the second layer 150 may be disposed above the first layer 140, and the third layer 160 may be disposed above the second layer 150. The liquids would then flow upwards into the mixing chamber 124 (such as at its centre area) and exit downwards via its periphery. Moreover, each layer of the chamber assembly 120 may itself include one or more layers. For example, the layer along which the liquids arrive at the chamber inlets 122 may be different from the layer along which the mixed liquids leave the mixing chamber 124 through the chamber outlets 126.

The microfluidic device 100 may include a plurality of reservoirs 170 disposed between the device inlets 110 and the chamber assembly 120, each reservoir 170 in fluid communication between a respective one of the device inlets 110 and the chamber inlets 122. The microfluidic device 100 may include a plurality of retention valves 172 disposed between the device inlets 110 and the reservoirs 170, each retention valve 172 in fluid communication between a respective one of the device inlets 110 and a respective one of the reservoirs 170. Each device inlet 110 is thus associated with one reservoir 170 and one retention valve 172, wherein the respective liquid in the device inlet 110 is fluidically communicable to the reservoir 170 via the retention valve 172.

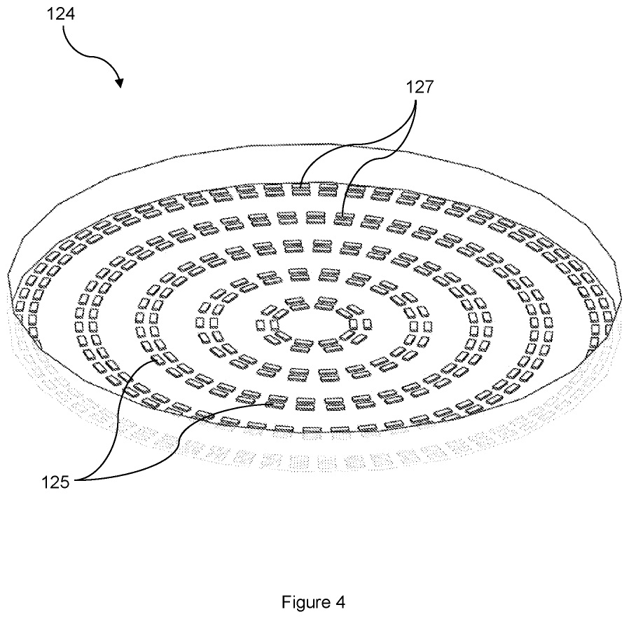

As shown in FIG. 5, each retention valve 172 may be a capillary valve 172. The capillary valves 172 are passive non-mechanical valves which operate by surface tension to restrict flow in microchannels 174. Due to capillary action created by the solid-liquid interface with the microfluidic device 100, the liquids will flow automatically from the device inlets 110 to the reservoirs 170 via the capillary valves 172. When all the draining ends of the liquids reach the capillary valves 172, liquid flow will stop due to the higher capillary pressure induced by the narrower microchannel geometry at the capillary valves 172. The retention valve 172 thus mitigates risk of uncontrolled moving and mixing of liquids when the microfluidic device 100 is in use during a measurement. To move the liquids from the reservoirs 170 towards the chamber inlets 122, a positive pneumatic pressure will be applied at the device inlets 110, as described further below.

Random emergence or presence of air bubbles in the mixing chamber 124 will influence and deteriorate the mixing and reaction efficiency and robustness. The microfluidic device 100 may include a debubbling assembly 180 disposed between the device inlets 110 and the chamber assembly 120. The debubbling assembly 180 is configured to debubble or remove bubbles from the liquids before the liquids reach the chamber assembly 120. For example, the debubbling assembly 180 is disposed such that it is in fluid communication between the reservoirs 170 and the chamber inlets 122.

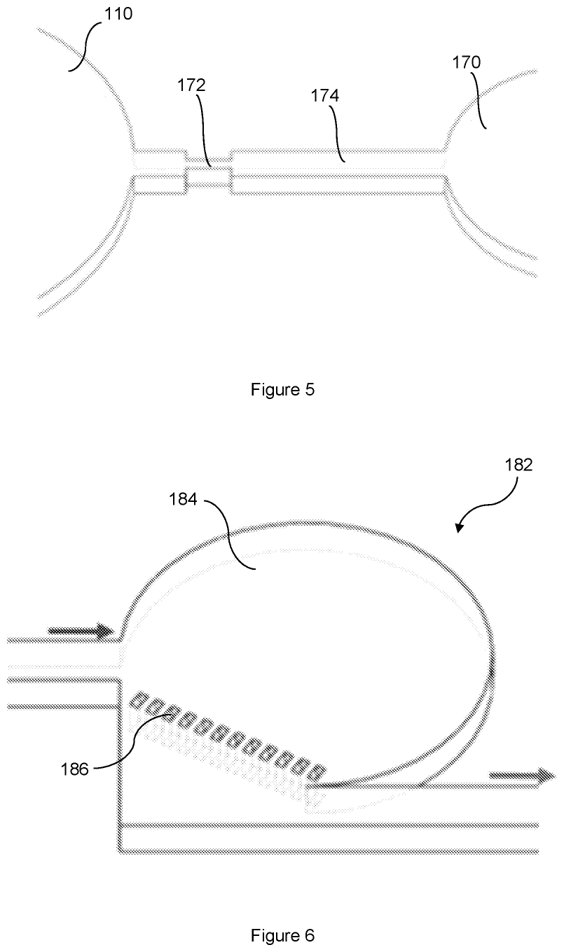

As shown in FIG. 6, the debubbling assembly 180 may include a set of one or more bubble traps 182 configured to trap bubbles and prevent the bubbles from communicating into the mixing chamber 124. A bubble trap 182 may include a trapping chamber 184 and a filter 186. The trapping chamber 184 may be large and cylindrical and is configured to reduce the fluidic drag force exerted on the bubbles, reducing the tendency for the bubbles to communicate away towards the chamber inlets 122. The filter 186, such as a micropillar filter, is configured to confine bubbles inside the trapping chamber 184 and allow debubbled liquids to pass through from the bubble trap 182. The bubble traps 182 may be arranged in a serial and/or parallel array to increase the debubbling efficiency and reduce the flow resistance change due to the blocking of individual bubble traps 182. The debubbling assembly 180 thus mitigates risk of potential bubbles from communicating into the mixing chamber 124, thereby improving robustness and reliability of the microfluidic device 100.

The microfluidic device 100 may be made of poly(methyl methacrylate) (PMMA). The overall size of the microfluidic device 100 may be 10×15×5 cm and the total weight may be below 50 g. The compact size and weight of the microfluidic device 100 allows it to be used as a general-purpose small-volume liquid handling device for various applications. For example, the microfluidic device 100 can be used in point-of-care medical diagnostics, environmental testing, food safety inspection, biohazard detection, and biological research.

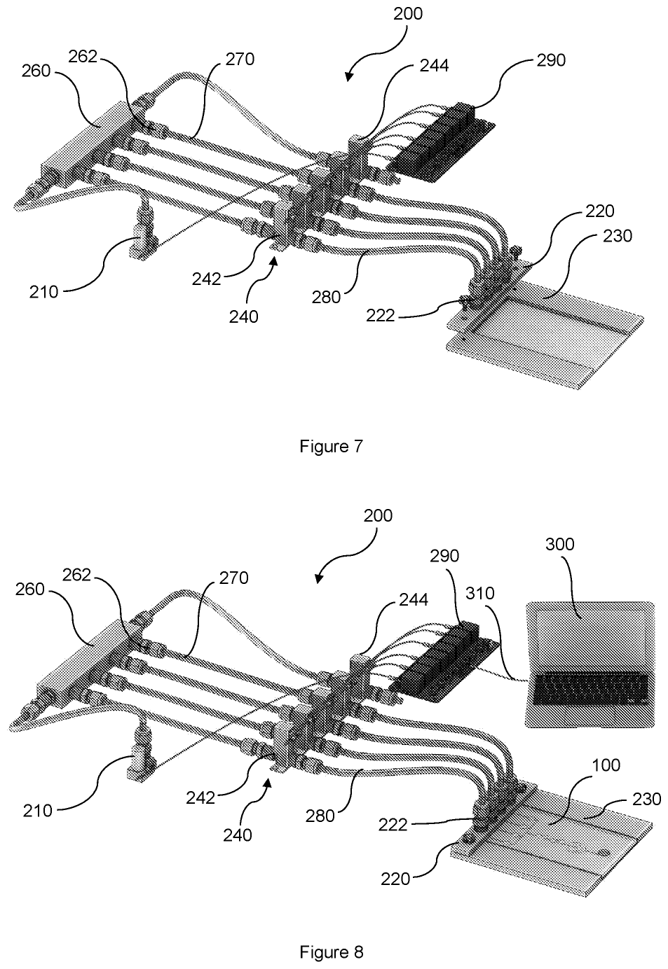

As described above, positive pneumatic pressure will be applied at the device inlets 110 to move the liquids through the microfluidic device 100. With reference to FIG. 7, there is a liquid control system 200 for controlling liquids in the microfluidic device 100. As used herein the term “system” can be applied to an arrangement of components, where one or more of those components may itself be a system. Such a component may be referred to as a “system” or a “subsystem”

The liquid control system 200 includes a pneumatic device 210 for pumping a gas, such as an inert gas or air. For example, the pneumatic device 210 is an electric-operated (at 1.5 to 4.5 V) positive displacement pump for pumping the gas at 150 ml per minute. Alternatively, the pneumatic device 210 is an air compressor for pumping compressed air. The pneumatic device 210 may be referred to as a pneumatic system or subsystem.

The liquid control system 200 includes a device connector 220 for connecting to the microfluidic device 100. The device connector 220 includes a plurality of inlet connectors 222, each inlet connector 222 for fluidically connecting to a respective one of the device inlets 110 of the microfluidic device 100. The liquid control system 200 may include a device holder 230 for holding the microfluidic device 100 to facilitate connection with the device connector 220. For example, the device connector 220 may be configured to clamp with the device holder 230 and securely connect the microfluidic device 100.

The liquid control system 200 further includes a valve assembly 240 comprising a plurality of valves 242 for fluidically connecting between the pneumatic device 210 and the device connector 220. Each valve 242 is fluidically communicable with a respective one of the inlet connectors 222 to control communication of the gas from the pneumatic device 210 through the respective valve 242 to the respective inlet connector 222. The valve assembly 240 may include a release valve 244 for releasing any residual pressure that may have accumulated in the liquid control system 200 after use.

The liquid control system 200 may include a manifold 260 fluidically connected between the pneumatic device 210 and the valve assembly 240 for distributing the gas at substantially even pressure to each valve 242. The manifold 260 may be a pneumatic manifold threaded fitting having a plurality of manifold outlets 262 corresponding to the number of valves 242 and inlet connectors 222.

The liquid control system 200 may include tubings 270, 280 fluidically connected between the manifold 260 and the valve assembly 240, and between the valve assembly 240 and the device connector 220, respectively. Specifically, each tubing 270 is fluidically connected between the manifold 260 and a respective one of the valves 242, and each tubing 280 is fluidically connected between a respective one of the valves 242 and a respective one of the inlet connectors 222.

The liquid control system 200 further includes a valve controller 290 configured to independently control operation of each valve 242 to, for each valve 242, controllably communicate the gas through the respective valve 242 and respective inlet connector 222 to the respective device inlet 110. Each valve 242 may be a solenoid valve and the valve controller 290 may be referred to as a relay controller. The valve controller 290 is configured to control either (i) opening and closing of each valve 242, or (ii) one of opening and closing where the valve 242 is biased to close or open when control is removed. For example, a solenoid valve may be biased towards one state (open or closed) with the valve controller 290 controlling it to move to the other state (closed or open).

As shown in FIG. 8, a control unit 300 is communicatively connected to the liquid control system 200 for controlling operation of the liquid control system 200. The control unit 300 may be a computer device such as a laptop or a microcontroller. The control unit 300 may be communicatively connected to the liquid control system 200 via a hardwire connection 310 such as a USB cable, or via a wireless communications protocol such as Wi-Fi or Bluetooth. The control unit 300 may be configured for controlling operation of the pneumatic device 210 and/or the valve controller 290.

In many embodiments as shown in FIG. 8, the microfluidic device 100 has four device inlets 110 for receiving four liquids. A precision instrument may be used to deposit the liquids into the respective device inlets 110. The liquid control system 200 has four corresponding control lines for controlling the liquids in the microfluidic device 100. Each control line includes the respective valve 242 and respective inlet connector 222. The control unit 300 may be programmed to automate the liquid control and handling process. In this process, each valve 242 is independently controlled for controlled communication of the gas to through the valve 242 and inlet connector 222 to the respective device inlet 110. The gas arriving at the device inlet 110 applies positive pneumatic pressure that thereby controls communication of the liquid in the device inlet 110. The positive pneumatic pressure pushes the liquid from the device inlet 110 to the chamber assembly 120 for subsequent mixing in the mixing chamber 124 with the other liquids from the other device inlets 110.

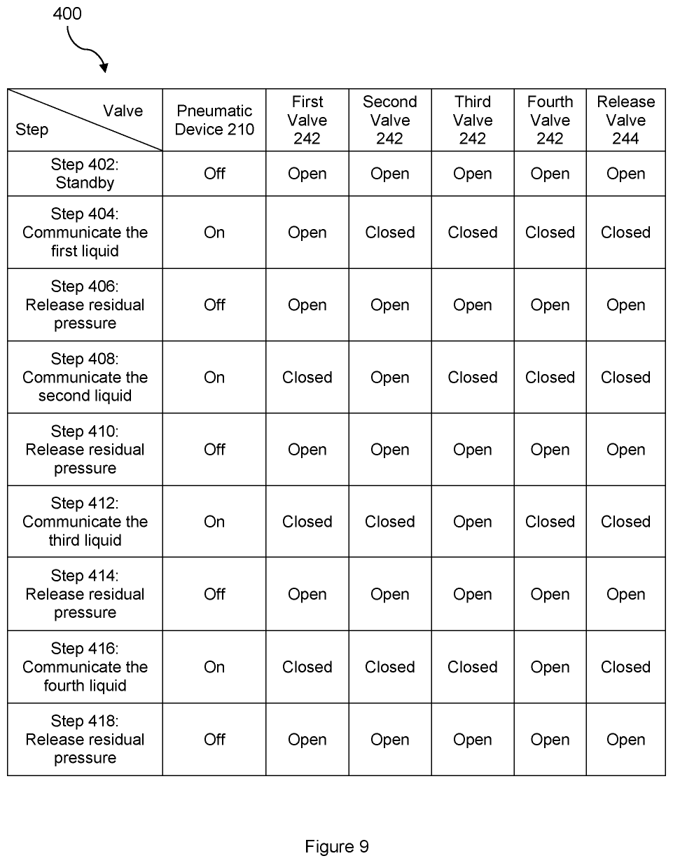

In an exemplary process 400 of controlling the liquids as shown in FIG. 9, the valves 242 are independently controlled by the valve controller 290 to sequentially communicate the liquids from the device inlets 110 to the mixing chamber 124 using the positive pneumatic pressure from only one pneumatic device 210. In step 402, the liquid control system 200 is in standby mode. The pneumatic device 210 is off and all four valves 242 and the release valve 244 are on or open.

In step 404, the liquid control system 200 is controlled to communicate the first liquid in the first device inlet 110. The pneumatic device 210 is on and the first valve 242 corresponding to the first device inlet 110 is open. The other three valves 242 and the release valve 244 are off or closed. In step 406, after the first liquid has communicated to the mixing chamber 124, the liquid control system 200 is controlled to release any residual pressure. The pneumatic device 210 is off and all four valves 242 and the release valve 244 are open.

In step 408, the liquid control system 200 is controlled to communicate the second liquid in the second device inlet 110. The pneumatic device 210 is on and the second valve 242 corresponding to the second device inlet 110 is open. The other three valves 242 and the release valve 244 are closed. In step 410, after the second liquid has communicated to the mixing chamber 124, the liquid control system 200 is controlled to release any residual pressure. The pneumatic device 210 is off and all four valves 242 and the release valve 244 are open.

In step 412, the liquid control system 200 is controlled to communicate the third liquid in the third device inlet 110. The pneumatic device 210 is on and the third valve 242 corresponding to the third device inlet 110 is open. The other three valves 242 and the release valve 244 are closed. In step 414, after the third liquid has communicated to the mixing chamber 124, the liquid control system 200 is controlled to release any residual pressure. The pneumatic device 210 is off and all four valves 242 and the release valve 244 are open.

In step 416, the liquid control system 200 is controlled to communicate the fourth liquid in the fourth device inlet 110. The pneumatic device 210 is on and the fourth valve 242 corresponding to the fourth device inlet 110 is open. The other three valves 242 and the release valve 244 are closed. In step 418, after the fourth liquid has communicated to the mixing chamber 124, the liquid control system 200 is controlled to release any residual pressure. The pneumatic device 210 is off and all four valves 242 and the release valve 244 are open.

Accordingly, all four liquids are sequentially communicated to the mixing chamber 124, and as the liquids flow from the chamber inlets 122 towards the chamber outlets 126, the liquid motion within the mixing chamber 124 facilitates uniform mixing of the liquids. A measurement or sensing element in the mixing chamber 124 may perform measurements on the mixed liquids, such as to sense chemical reactions in the mixed liquids for assaying. The mixed liquids may be allowed to incubate in the mixing chamber 124 for a period of time before the measurements, depending on what type of reactions are expected from the mixed liquids.

After the measurements, the liquids may be purged from the mixing chamber 124. For example, the pneumatic device 210 and valve assembly 240 are controlled to pump gas into the microfluidic device 100 and purge the liquids. The microfluidic device 100 may then be cleaned and sterilized for reuse. Alternatively, the microfluidic device 100 may be designed for one-time use and disposed after the measurements.

An advantage of the liquid control system 200 the avoidance of contact between the liquid control system 200 and the liquids in the microfluidic device 100, thus preventing the liquids from fluidically mixing with the liquid control system 200. The liquid control system 200 provides the pressure source in the form of a gas which minimizes cross contamination with the liquids. The liquid control system 200 also has the capability for reuse with batches of microfluidic devices 100. Another advantage is that the process 400 can be controlled by the control unit 300 and performed automatically without or with minimal manual intervention. The control unit 300 may provide a custom-built program for precise controls and regulations of various parameters including pneumatic pressure, flow sequence, flow rate, flow duration, and targeted liquid loading.

The liquid control system 200 is reusable and has no contact with clinical samples (the liquids in the microfluidic device 100). The microfluidic device 100 can also be produced cheaply and as a disposable product. The liquid control system 200 can be combined with various measurement or detection systems to develop a dedicated platform for various applications. For example, the platform can be applied in clinical applications such as point-of-care medical diagnostics. Such a platform would enable inexpensive, automatic, and safe point-of-care medical diagnostics. Comparatively, current clinic diagnostics require expensive equipment and laboratory-trained personnel. The platform can be scaled up to cater for a wide range of measurement or detection methodologies such as optical, electrical, and electrochemical detections.

The microfluidic device 100 can be fabricated by various manufacturing methods. For example, the microfluidic device 100 may be fabricated reliably on a large scale by injection moulding. In some embodiments, the microfluidic device 100 or a product comprising it may be formed by a manufacturing process that includes an additive manufacturing process. A common example of additive manufacturing is three-dimensional (3D) printing; however, other methods of additive manufacturing are available. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a 3D component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using prior manufacturing methods.

Additive manufacturing methods described herein enable manufacture to any suitable size and shape with various features which may not have been possible using prior manufacturing methods. Additive manufacturing can create complex geometries without the use of any sort of tools, moulds, or fixtures, and with little or no waste material. Instead of machining components from solid billets of plastic or metal, much of which is cut away and discarded, the only material used in additive manufacturing is what is required to shape the part.

Suitable additive manufacturing techniques in accordance with the present disclosure include, for example, Fused Deposition Modelling (FDM), Selective Laser Sintering (SLS), 3D printing such as by inkjets and laserjets, Stereolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNS), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM), and other known processes.

The additive manufacturing processes described herein may be used for forming components using any suitable material. For example, the material may be metal, plastic, polymer, composite, or any other suitable material that may be in solid, liquid, powder, sheet material, wire, or any other suitable form or combinations thereof. More specifically, according to exemplary embodiments of the present disclosure, the additively manufactured components described herein may be formed in part, in whole, or in some combination of materials suitable for use in additive manufacturing processes and which may be suitable for the fabrication of examples described herein.

As noted above, the additive manufacturing process disclosed herein allows a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on 3D information, for example a 3D computer model (or design file), of the component. Accordingly, examples described herein not only include products or components as described herein, but also methods of manufacturing such products or components via additive manufacturing and computer software, firmware or hardware for controlling the manufacture of such products via additive manufacturing.

The structure of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for Stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any 3D object to be fabricated on any additive manufacturing printer. Further examples of design file formats include AutoCAD (.dwg) files, Blender (.blend) files, Parasolid (.x_t) files, 3D Manufacturing Format (.3mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product. Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known CAD software systems such as AutoCAD®, TurboCAD®, DesignCAD 3D Max, etc. Alternatively, a model or prototype of the product may be scanned to determine the 3D information of the product. Accordingly, by controlling an additive manufacturing apparatus according to the computer executable instructions, the additive manufacturing apparatus can be instructed to print out the product.

In light of the above, embodiments include methods of manufacture via additive manufacturing. This includes the steps of obtaining a design file representing the product and instructing an additive manufacturing apparatus to manufacture the product according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing apparatus. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing apparatus.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

In the foregoing detailed description, embodiments of the present disclosure in relation to the microfluidic device and liquid control system are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A microfluidic device for mixing liquids, the microfluidic device comprising:
a plurality of device inlets, each device inlet for receiving a liquid;
a chamber assembly comprising:
a set of chamber inlets in fluid communication with the device inlets;
a mixing chamber for receiving the liquids through the chamber inlets; and
a plurality of chamber outlets for communicating the liquids away from the mixing chamber; and
a set of device outlets in fluid communication with the chamber outlets,
wherein the chamber outlets are spaced around the mixing chamber such that the mixing chamber facilitates uniform mixing of the liquids communicating from the chamber inlets to the chamber outlets.

2. The microfluidic device according to claim 1, wherein the chamber assembly comprises:
a first layer comprising the chamber inlets and chamber outlets;
a second layer comprising vias respectively connecting each chamber inlet and chamber outlet to the mixing chamber; and
a third layer comprising the mixing chamber.

3. The microfluidic device according to claim 1, wherein the chamber inlets comprise a first chamber inlet positioned to direct the liquids into a centre area of the mixing chamber.

4. The microfluidic device according to claim 3, wherein the mixing chamber comprises an array of guiding elements for regulating communication of the liquids from the first chamber inlet to the chamber outlets.

5. The microfluidic device according to claim 4, wherein the guiding elements are concentrically arranged such that the liquids are communicated radially from the first chamber inlet to the chamber outlets.

6. The microfluidic device according to claim 3, wherein the chamber outlets are equidistantly spaced from the first chamber inlet.

7. The microfluidic device according to claim 1, wherein the chamber outlets are equidistantly spaced from each other.

8. The microfluidic device according to claim 1, wherein the chamber outlets are spaced around a periphery of the mixing chamber.

9. The microfluidic device according to claim 1, further comprising a debubbling assembly disposed between the device inlets and the chamber assembly, the debubbling assembly configured for debubbling the liquids.

10. The microfluidic device according to claim 9, wherein the debubbling assembly comprises a set of bubble traps.

11. The microfluidic device according to claim 10, wherein each bubble trap comprises a filter for debubbled liquids to pass through from the bubble trap.

12. The microfluidic device according to claim 1, further comprising a plurality of reservoirs disposed between the device inlets and the chamber assembly.

13. The microfluidic device according to claim 12, further comprising a plurality of retention valves disposed between the device inlets and the reservoirs.

14. The microfluidic device according to claim 13, wherein each device inlet is associated with one reservoir and one retention valve.

15. (canceled)

16. The microfluidic device according to claim 1, further comprising a measurement element for measuring the mixed liquids in the mixing chamber.

17. A liquid control system for controlling liquids in a microfluidic device, the liquid control system comprising:
a pneumatic device for pumping a gas;
a device connector for connecting to the microfluidic device, the device connector comprising a plurality of inlet connectors, each inlet connector for fluidically connecting to a respective device inlet of the microfluidic device;
a valve assembly comprising a plurality of valves for fluidically connecting between the pneumatic device and device connector, each valve fluidically communicable with a respective inlet connector to control communication of the gas from the pneumatic device through the respective valve to the respective inlet connector; and
a valve controller configured to independently control operation of each valve to, for each valve, controllably communicate the gas through the respective valve and respective inlet connector to the respective device inlet,
wherein controlled communication of the gas to each device inlet thereby controls communication of a liquid in the respective device inlet.

18. The liquid control system according to claim 17, further comprising a manifold for fluidically connecting between the pneumatic device and the valve assembly for distributing the gas at substantially even pressure to each valve.

19. (canceled)

20. The liquid control system according to claim 17, wherein the operation of the pneumatic device and/or the valve controller is controllable by a control unit communicatively connected to the liquid control system.

21. A computer program comprising computer executable instructions that, when executed by a processor, cause the processor to control an additive manufacturing apparatus to manufacture a product comprising the microfluidic device according to claim 1.

22. A method of manufacturing a product via additive manufacturing, the method comprising:
obtaining an electronic file representing a geometry of the product wherein the product comprises the microfluidic device according to claim 1; and
controlling an additive manufacturing apparatus to manufacture, over one or more additive manufacturing steps, the product according to the geometry specified in the electronic file.
